(19) United States
(12) Patent Application Publication
(10) Pub. No.: US 2012/0059667 A1
(43) Pub. Date: Mar. 8, 2012

(54) System and method for preventing malpractices and negligences

(76) Inventor: Anuthep Benja-athon, New York, NY (US)

(21) Appl. No.: 13/373,165

(22) Filed: Nov. 8, 2011

Related U.S. Application Data
(63) Continuation-in-part of application No. 13/199,231, filed on Aug. 24, 2011.
Application No. 13/199,231 is a continuation-in-part of application No. 13/134,139, filed on May 31, 2011.
Application No. 13/134,139 is a continuation-in-part of application No. 13/065,518, filed on Mar. 24, 2011.
Application No. 13/065,518 is a continuation-in-part of application No. 12/156,674, filed on Jun. 4, 2008, now abandoned.
Application No. 13/199,231 is a continuation-in-part of application No. 12/924,054, filed on Sep. 20, 2010.
Application No. 12/924,054 is a continuation-in-part of application No. 12/804,588, filed on Jul. 26, 2010.
Application No. 12/804,588 is a continuation-in-part of application No. 12/799,207, filed on Apr. 21, 2010.
Application No. 12/799,207 is a continuation-in-part of application No. 12/658,112, filed on Feb. 3, 2010, now abandoned.
Application No. 12/658,112 is a continuation-in-part of application No. 12/655,748, filed on Jan. 7, 2010.
Application No. 12/655,748 is a continuation-in-part of application No. 12/381,654, filed on Mar. 16, 2009.
Application No. 13/199,231 is a continuation-in-part of application No. 12/321,141, filed on Jan. 16, 2009.
Application No. 12/321,141 is a continuation-in-part of application No. 12/069,409, filed on Feb. 11, 2008, now abandoned.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007, now abandoned.
Application No. 13/199,231 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/22

(52) U.S. Cl. 705/2

(57) ABSTRACT

A system and method for server-coordinating health-cares and services between and among patients and physicians to prevent medical malpractices, delays, errors, inaccuracies, inefficiencies, mistakes, morbidity and mortality by computer servers, communication devices and teleconferencing platforms in a network or networks of severs, devices and platforms.

This application is a continuation-in-part of Ser. No. 13/199,231 entitled A system and method for health-care continuities and vigilances filed Aug. 24, 2011, a continuation-in-part of Ser. No. 13/134,139 entitled Brains-Server Synapses-Empowered Networking filed May 31, 2011, a continuation-in-part of Ser. No. 13/065,518 entitled Brains-empowered networking filed Mar. 24, 2011, a continuation-in-part of Ser. No. 12/156,674 entitled A precise medical information retrieval filed Jun. 4, 2008 (abandoned), a continuation-in-part of Ser. No. 12/924,054 entitled A server-guidance of health-care I filed Sep. 20, 2010, a continuation-in-part of Ser. No. 12/804,588 entitled An intelligent computer-biological electronic-neural health-care system filed Jul. 26, 2010, a continuation-in-part of Ser. No. 12/799,207 entitled Computer-created-consensus-based health-care system filed Apr. 21, 2010, a continuation-in-part of Ser. No. 12/658,112 entitled A system and method for computer-generations of diagnoses filed Feb. 3, 2010 (abandoned), a continuation-in-part of Ser. No. 12/655,748 entitled the Artificial-intelligent system and method for managing health-care filed Jan. 7, 2010, a continuation-in-part of Ser. No. 12/381,654 filed Mar. 16, 2009 entitled the Adaptable compositions of health information, a continuation-in-part of Ser. No. 12/321,141 entitled the Best system of health and health-care data management filed Jan. 16, 2009, a continuation-in-part of Ser. No. 12/069,409 entitled the Filing of Health and Health-care data filed Feb. 11, 2008 (abandoned), continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

The coordination and safeguards of health-cares and health-care services for physicians and patients by a network or networks of computer servers, teleconferencing platforms and computers and mobile devices.

### BACKGROUND OF THE INVENTION

The medical malpractices, delays, inefficiencies, errors, mistakes, morbidity and mortality related to the health of and health-cares and health-care services provided to patients by physicians are attributable to physicians lacking skills, expertise, negligent, time, attentions, thoroughness, care and any combination thereof. The intangible consequences are immense and tangible losses are in hundreds of billions of dollars per annum in America.

Furthermore, first, supra occurred and will continue to occur as physicians are humans capable and prone to commit supra leading to adverse consequences such as, but not limited to, said medical malpractices and related socioeconomic consequences and pain and suffering on millions of physicians—who devoted a life time pursuing said noble profession and endeavor—and billions of patients and their families.

Furthermore, second, patients are so inefficiently, ineffectively and archaically diagnosed, treated and manage in the status quo health-care systems and will continue to be so without the present invention.

Specifically, the present invention provides the system and method for the best preventive medicine and best physicians-patients-coordinated cares for, between and among physicians and patients and the best prevention of said adversities and people's behaviors and actions related to health-cares affecting billions of people and immensely improve the quality and quantity of health-cares and therefore better living for people.

### SUMMARY OF THE INVENTION

In the status quo health-care, intangible losses and hundreds of billions of dollars per annum in America in tangible losses are lost to patients and physicians and there is nothing which can prevent these losses which are growing resulting in lower standard of living for above people and, consequently, increase morbidity and mortality.

The present invention provides a system and method for coordinating health-cares and services between and among patients and physicians to reduce or prevent medical malpractices, delays, errors, inaccuracies, inefficiencies, mistakes, morbidity and mortality by computer servers, communication devices and teleconferencing platforms in a network or networks of severs, devices and platforms. The present invention ends said losses with immense benefits for said people.

### DESCRIPTION OF THE PREFERRED EMBODIMENTS

The present invention provides the networks of individual physicians, individual patients, individual groups of physicians and individual groups of physicians and patients in diverse and different settings, circumstances and locations henceforth people and computer servers, teleconferencing platforms including video conferencing henceforth platforms and computers, laptops, hand-held and mobile and wireless communication devices and equipment for accessing and interacting with said servers and platforms henceforth devices being used by people networked to said computers servers adaptable to technologically push, pull, forward, disseminate, share and/or stream relational information and data on health and health-care, including laboratory-generated laboratory data, related to, created and generated and submitted by said people to the processor units and memories of said computer servers and compiled and related as said relational information and data in and among SQL tables in SQL databases in and manage by a SQL server in said computer servers wherein said adaptable relational information and data are displayed on the viewing screens and interactive with, among and between and according to for computer servers-guiding and assisting in diagnosing, managing, treating, preventing and controlling diseases, illnesses and disorders and related developments, courses, risks, recurrences, progressions and preventions for, by, among and between said people using said networks.

The present invention provides a system and method for reducing medical malpractices, delays, errors, inaccuracies, inefficiencies, mistakes, morbidity and mortality related to the health of and health-cares and health-care services provided to patients by physicians and health-care providers henceforth physicians for physicians and patients by a network or networks of computer servers, communication devices and platforms.

The present invention provides said innovative computer programs and software including stored procedures to instruct and cause said processors and memories to generate adaptable and expanding relations and compilations of individual diagnoses and/or syndromes, diagnoses and/or syndromes in individual groups of diagnoses and/or syndromes affecting organs, parts and anatomical sites of humans and related information and data in various headings encompassing related signs, symptoms, chief complaints and PQRST, differential diagnoses, reviews of systems, physical examinations, laboratories, imaging, body fluid tests and tissues examinations, organs and anatomical sites and parts of human, family histories, physiology, genetics, immunizations, treatments, surgeries, procedures, medications, drugs and therapeutics and effects and side-effects on human organs and bodies of said medications, drugs and therapeutics and related prescriptions, uses, weanings, discontinuations and related sequelae, guidelines, protocols, referrals, recommendations related to individual patients, patients, patients' identities, individual physicians, physicians, physicians in individual groups of physicians, physicians' identities and physicians' specialties and/or practices henceforth people, people's identities and specialties in all medical and surgical specialties and related relations of SQL keys—based on earlier taught SQL units and relations of elements or components and related SQL keys between and among said SQL units in and among SQL tables, adopted by one of the preferred embodiments of the present invention—in said SQL databases and tables. Said process is well taught in said pending patent applications to achieve extensive and comprehensive said adaptable and expanding relations and compilations related to relations of SQL keys in said in said SQL databases and tables which enabled said pending patents and present invention to achieve their objectives and goals. In several pending patents, said adaptable and expanding relations and compilations related to individual patients and related physicians are compiled by said processors and memories and displayed and interactive adaptable and expanding relations and compilations interactive with and/or among individual physicians, physicians, individual patients, patients, physicians in individual groups of physicians or physicians and individual patients in individual groups of physicians and patients henceforth people in said viewing screens in said network or networks.

Using at least one of said preferred embodiments, the present invention provides said innovative computer programs and software including stored procedures to instruct and cause said processor and memories to compose, generate and adapt individual idiosyncratic or characteristic compositions of individual diagnoses and/or syndromes, diagnoses and/or syndromes in individual groups of diagnoses and/or syndromes and related information and data in various headings and related people, people's identities and specialties from said adaptable and expanding relations and compilations related to relations of SQL keys in said SQL databases and tables in responses to said people's inputs health, health-care and health-care services into said processors and memories using said devices and platforms in said network or networks.

The present invention provides said innovative computer programs and software including stored procedures instruct and cause said processors and memories and said commercial computer programs and software to cause said compositions of idiosyncratic or characteristic compositions to be associate with and be interactive in interactive adaptable and expanding relations and compilations in said viewing screens being used by said people. Said compositions of idiosyncratic or characteristic compositions are—i. said adaptable and expanding relations and compilations in said SQL tables and databases; ii. said adaptable and expanding and interactive relations and compilations related to said people, people's identities and specialties in said viewing screens; iii. said individual idiosyncratic or characteristic compositions of individual diagnoses and/or syndromes, diagnoses and/or syndromes in individual groups of diagnoses and/or syndromes and related information and data in various headings derived from said adaptable and expanding relations and compilations.

In other words, one of the preferred embodiments of the present invention provides for said processor-generated compositions of individual unique compositions comprise: i. individual pooled consensuses, guidelines and protocols related to people, people's identities and specialties; ii. individual diagnoses and/or syndromes, diagnoses and/or syndromes in individual groups of diagnoses and/or syndromes and related information and data in said various headings and related differential diagnoses and related people, people's identities and specialties; and iii. extrapolations or forecasts of illnesses, diseases and disorders and related sequelae related to individual diagnoses and/or syndromes, diagnoses and/or syndromes in individual groups of diagnoses and/or syndromes and related information and data in various headings and related people, people's identities and specialties and related differential diagnoses related to individual diagnoses and/or syndromes, diagnoses and/or syndromes in individual groups of diagnoses and/or syndromes and information and data in various headings and related people, people's identities and specialties related and compiled in said adaptable and expanding relations and compilations; and enabled by said commercial computer programs and software infra, in associations with said individual adaptable, expanding and interactive relations and compilations in said interactive relate Web pages in said viewing screens being used by said people to prevent or reduce said medical malpractices, delays, inefficiencies, mistakes, morbidity and mortality for physicians and patients enabled by said innovative computer programs and software including stored procedures instructing and causing said processors, memories and commercial computer programs and software in said network or networks.

The present invention provides a system and method for reducing medical malpractices, delays, errors, inaccuracies, inefficiencies, mistakes, morbidity and mortality related to the health of and health-cares and health-care services provided to patients by physicians and health-care providers henceforth physicians for physicians and patients by a network or networks of computer servers, communication devices and platforms by providing functioning and operating said computer servers including virtual servers comprising a plurality of processors, memories, server operating systems, SQL Server, computer scripting languages, html, Java Script, Ajax coupled to innovative computer programs and software including stored procedures and various commercially available hardware including, but not limited to, routers, switches, modems and computer programs and software for technically pushing, pulling, file sharing and streaming and networking said servers and communication devices comprising computers, laptops, computer tablets, mobile and wireless communication devices possessing viewing screens including touch-enabled screens or touchscreens, keypads, Web browsers and speech recognition technologies and said platforms comprising teleconferencing platforms including video conferencing and said viewing screens and networking capability for technologically pushing, pulling, forwarding, disseminating, sharing and streaming said relational information and data to, between and among said servers, devices and platforms connected to the Internet.

The present invention provides said-processor-generated individual interactive diagnoses and/or syndromes and related differential diagnosis or diagnoses and related interactive information and data related to said headings and related to people, people's identities and specialties generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and said related interactive information and data in related interactive Web pages in said viewing screens;

said-processor-generated individual pooled consensuses, guidelines and protocols comprising individual interactive diagnoses and/or syndromes and related interactive information and data generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and related interactive information and data in related interactive Web pages in said viewing screens;

said-processor-generated extrapolations or predictions of individual diseases, illnesses and/or disorders and related individual interactive diagnoses and/or syndromes, diagnoses and/or syndromes in individual groups of diagnoses and/or syndromes and related interactive information and data in said headings from said adaptable and expanding relations and compilations in and among said SQL tables and databases related to said processor-generated individual diagnoses or syndromes and related information and data and related to said processor-generated individual pooled consensuses, guidelines and protocols related to individual diagnoses and/or syndromes and related information and data related to individual patients in associations with said processor-generated adaptable and expanding relations and compilations of individual interactive diagnoses and/or syndromes, diagnoses and/or syndromes in individual groups of diagnoses and/or syndromes and related interactive information and data in related interactive Web pages in said viewing screens;

said-processor-generated means for preventing or reducing said medical malpractices, delays, inefficiencies, mistakes, morbidity and mortality for physicians in associations as interactive means for preventing or reducing with said-processor-generated adaptable and expanding relations and compilations in said related interactive Web pages in said viewing screens;

said innovative computer programs and software for instructing and said processors and memories and said commercial computer programs and software for technologically and continually pushing, pulling, forwarding, disseminating, sharing and streaming said interactive means for preventing or reducing in associations with said processor-generated adaptable and expanding relations and compilations in interactive related Web pages in said viewing screens of said computer servers, devices and platforms in said network or networks;

said-processor-generated means for coordinating said health-cares and health-care services between and among patients and physicians in associations as interactive means for coordinating with said-processor-generated adaptable and expanding relations and compilations in said related interactive Web pages in said viewing screens;

said innovative computer programs and software, processors and memories and computer programs and software, processors and memories for preventing or reducing said medical malpractices, delays, delays, inefficiencies, mistakes, morbidity and mortality for said people in said network or networks; and

said innovative computer programs and software, processors and memories and said commercial computer programs and software for generating said adaptable and expanding relations and compilations, means for preventing or reducing means for and means for coordinating in said network or networks.

Further to supra, the present invention provides a method for preventing or reducing said medical malpractices, delays, delays, inefficiencies, mistakes, morbidity and mortality for said people by said servers, devices and platforms in said network or networks comprises:

a process for operating said functioning and operating functioning said computer servers including virtual servers comprising a plurality of processors, memories, server operating systems, SQL Server, computer scripting languages, html, Java Script, Ajax coupled to innovative computer programs and software including stored procedures and various commercially available hardware including, but not limited to, routers, switches, modems and computer programs and software for technically pushing, pulling, file sharing and streaming and networking said servers and communication devices comprising computers, laptops, computer tablets, mobile and wireless communication devices possessing viewing screens including touch-enabled screens or touchscreens, keypads, Web browsers and speech recognition technologies and said platforms comprising teleconferencing platforms including video conferencing and said viewing screens and networking capability for technologically pushing, pulling, forwarding, disseminating, sharing and streaming said relational information and data to, between and among said servers, devices and platforms connected to the Internet;

said innovative computer programs and software including stored procedures instruct and cause said processors and memories to generate adaptable and expanding relations and compilations comprising individual diagnoses and/or syndromes, diagnoses and/or syndromes in individual groups of diagnoses and/or syndromes affecting organs, parts and anatomical sites of humans and related information and data in various headings encompassing related signs, symptoms, chief complaints and PQRST, differential diagnoses, reviews of systems, physical examinations, laboratories, imaging, body fluid tests and tissues examinations, organs and anatomical sites and parts of human, family histories, physiology, genetics, risks, risk factors, predispositions, sequelae, complications, immunizations, treatments, surgeries, procedures, medications, drugs and therapeutics and effects and side-effects on human organs and bodies of said medications, drugs and therapeutics and related prescriptions, uses, weanings, discontinuations and related sequelae, guidelines, protocols, referrals, recommendations and related individual patients, patients, patients' identities, individual physicians, physicians, physicians in individual groups of physicians, physicians' identities and physicians' specialties and/or practices henceforth people, people's identities and specialties and related relations of SQL keys in said SQL databases and tables;

said innovative computer programs and software instruct and cause said processors and memories and said commercial computer programs and software to generate individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;

said innovative computer programs and software, processors and memories and said commercial computer programs and software for generating said adaptable and expanding relations and compilations, means for preventing or reducing means for and means for coordinating and associating said means with said individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;

said innovative computer programs and software instruct and cause said processors and memories and commercial computer programs and software to generate said means for preventing or reducing said medical malpractices, delays, delays, inefficiencies, mistakes, morbidity and mortality for physicians and to associate said means as interactive means with said individual adaptable, expanding and interactive relations and compilations in said in individual related interactive electronic Web pages interactive with said individual patients and related physicians in said viewing screens in said network or networks which are:

said innovative computer programs and software instruct and cause said processors and memories and said computer programs and software to associate or relate said means for preventing or reducing as interactive means to said individual adaptable, expanding and interactive relations and compilations in said interactive relate Web pages in said viewing screens of said servers, devices and platforms being used by said people;

said innovative computer programs and software instruct and cause said processors and memories to select individual diagnoses and/or syndromes and related differential diagnosis or diagnoses in said adaptable and expanding relations and compilations in individual responses to any components in said headings inputted into said processors and memories by said people using information and data in said headings in said viewing screens and said computer programs and software to display said processor-selected individual diagnoses and/or syndromes and related information and data related to said headings and related to people, people's identities and specialties and related differential diagnosis or diagnoses in said interactive compositions and interactive with said people in said viewing screens;

if said processor-generated individual diagnoses or syndromes and related information and data were selected by individual physicians or between or among physicians in a group physicians using clicks, keyboards, touches, speech recognition or any combination thereof, first, said innovative computer programs and software instruct and cause said processors and memories to process said selected individual diagnoses or syndromes and related information and data and related differential diagnosis or diagnoses and to compile and relate in said adaptable and expanding relations and compilations in and among said SQL tables and databases, and, consequently, said commercial computer programs and software to technogically push, pull, forward and stream said diagnoses and related information and data and related differential diagnosis or diagnoses in said interactive compositions in said viewing screens;

second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related said information and in said headings related to individual patients and related physicians related to said processor-generated individual diagnoses or syndromes and related information and data from said adaptable and expanding relations and compilations and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties to associate with said interactive compositions in said viewing screens being used by said people;

said innovative computer programs and software instruct and cause said processors and memories to compose individual pooled consensuses, guidelines and protocols related to individual diagnoses and/or syndromes and related information and data in said headings from said adaptable and expanding relations and compile and associate said individual pooled consensuses, guidelines and protocols with said individual diagnoses and/or syndromes, diagnoses and/or syndromes in individual groups of diagnoses and/or syndromes in said interactive compositions in said viewing screens, after said processors and memories received any components of said headings inputted into said processors and memories by individual patients and/or physicians;

if said processor-generated individual pooled consensuses, guidelines and/or protocols and related information and data in said headings were selected and submitted to said processors and memories by individual physicians or between or among physicians in a group physicians, first, said innovative computer programs and software instruct and cause said processors and memories to process said inputs and to compile and relate in said adaptable and expanding relations and compilations in and among said SQL tables and databases, and, consequently, said commercial computer programs and software to technologically push, pull, forward and stream said diagnoses and related information and data in said interactive compositions in said viewing screens being used by said people;

said innovative computer programs and software instruct and cause said processors and memories to identify and select said individual diagnoses and related treatments and managements of diseases, illnesses and disorders and related prescriptions, uses, discontinuations and weanings of related medications and/or treatments in said adaptable and expanding relations and compilations according to said consensuses, guidelines and protocols;

second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related information and data related to individual patients and physicians related to said selected and submitted information and data submitted to said processors and memories comprising and related information and data from said adaptable and expanding relations and compilations in and among said SQL tables and databases and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties in said viewing screens being used by said people; and

said innovative computer programs and software including stored procedures instruct and cause said processors and memories extrapolate or predict individual diseases, illnesses and/or disorders and related individual interactive diagnoses and/or syndromes, diagnoses and/or syndromes in individual groups of diagnoses and/or syndromes and related interactive information and data generated from said adaptable and expanding relations and compilations related to said-processor-generated individual diagnoses or syndromes and related information and data and related to said-processor-generated individual pooled consensuses, guidelines and protocols related to individual diagnoses and/or syndromes and related information and data related to individual patients and physicians in associations with said-processor-generated adaptable and expanding relations and compilations of interactive individual diagnoses and/or syndromes, diagnoses and/or syndromes in individual groups of diagnoses and/or syndromes and related interactive information and data related to people, people's identities and specialties and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said identities and specialties in said viewing screens being used by said people.

Further to supra, the present invention provides a method for coordinating said health, health-cares and services between and among patients and physicians by said computer servers, communication devices and platforms in said network or networks to reduce or prevent said malpractices, delays, errors, inaccuracies, inefficiencies, mistakes, morbidity and mortality comprises:

said process for operating said functioning and operating said computer servers comprising said processors and memories coupled to said innovative computer programs and software including stored procedures and commercial computer programs and software in said network or networks of said servers, devices, platforms and Internet;

said innovative computer programs and software instruct and cause said processors and memories and said commercial computer programs and software to generate individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;

said innovative computer programs and software instruct and cause said processors and memories and commercial computer programs and software to generate said means for preventing or reducing said medical malpractices, delays, delays, inefficiencies, mistakes, morbidity and mortality for physicians and to associate said means as interactive means with said individual adaptable, expanding and interactive relations and compilations in said in individual related interactive electronic Web pages interactive with said individual patients and related physicians in said viewing screens in said network or networks;

said innovative computer programs and software instruct and cause said processors and memories and commercial computer programs and software to generate said means for coordinating said health-cares and health-care services between and among patients and physicians and to associate as interactive means with said-processor-generated adaptable and expanding relations and compilations in said related interactive Web pages in said viewing screens to reduce or prevent said malpractices, delays, errors, inaccuracies, inefficiencies, mistakes, morbidity and mortality for physicians and patients by said servers, devices and platforms in said network or networks;

said innovative computer programs and software, processors and memories and said commercial computer programs and software for generating said adaptable and expanding relations and compilations, means for preventing or reducing means for and means for coordinating and associating said means with said individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;

said innovative computer programs and software instruct and cause said processors and memories and said commercial computer programs and software to technologically and continually push, pull, forward, stream and disseminate said individual interactive pooled consensuses, guidelines and protocols related to individual diagnoses and/or syndromes, diagnoses and/or syndromes in individual groups of diagnoses and/or syndromes and related information and data in said various headings and related differential diagnoses and related and extrapolations or forecasts and related people, people's identities and specialties and to associate as interactive means for preventing or reducing and means for coordinating with said individual adaptable, expanding and interactive relations and compilations in individual related interactive electronic Web pages interactive with said individual patients and related physicians in said viewing screens in said network or networks; and

said innovative computer programs and software instruct and cause said processors and memories and said computer programs and software to visually contrasting, distinguishing and highlighting individual diagnoses, syndromes, diagnoses and syndromes, differential diagnoses and related information and data in said various headings and people, people's identities and specialties in and among said pushed, pulled, forwarded, streamed and disseminated said individual interactive pooled consensuses, guidelines, protocols, diagnoses, syndromes, differential diagnoses and extrapolations or forecasts and related people, people's identities and specialties and related interactive information and data in said related interactive electronic Web pages to be interactive in said viewing screen with said people using said devices and platforms; and

said innovative computer programs and software, computer programs and software, processors and memories to prevent or reduce said medical malpractices, delays, delays, inefficiencies, mistakes, morbidity and mortality for said people in said network or networks; and

said innovative computer programs and software, computer programs and software, processors and memories to coordinate health-cares and health-care services between and among patients and physicians in said network or networks.

A vital fundamental of the present invention applicable, but not limited to, said means and method for coordinating and means and method for preventing or reducing said medical malpractices, delays, delays, inefficiencies, mistakes, morbidity and mortality by said servers, devices and platforms also provides a means for optimizing the effects of said means for preventing or reducing between and among said people by providing means for visually, auditory and/or sound contrasting or distinguishing said contents and components of said products and outcomes such as, but not limited to, said diagnoses, syndromes, diagnoses and/or syndromes and related information and data in said various headings, differential diagnoses and related information and data in said various headings and people, people's identities and specialties in and among said pushed, pulled, forwarded, streamed and disseminated said individual interactive pooled consensuses, guidelines, protocols, diagnoses, syndromes and related information and data and related people, people's identities and specialties and extrapolations or forecasts in said related interactive electronic Web pages to be interactive with said people in said viewing screen. Said means for visually contrasting, distinguishing and/or contrasting are such as, but not limited to, colors, images, figurines, pictures, symbols and illustrations.

The present invention provides a network or networks of functioning and operating commercially available computer servers including virtual servers and their derivatives comprising a plurality of processor units, memories, server operating system, said devices and platforms, SQL Server, computer scripting languages, html, various commercially available computer programs and software such as, but not limited to Java, JavaScript, AJAX, HTML, .net, Wordpad, Notepad, .txt, Flash and video enabled programs, various commercial available hardware and equipment such as, but not limited to, routers, switches, modems and commercial and free computer programs and software and source codes for enabling and effecting the networking and processes in the present invention, push, pull, file sharing and streaming technologies and a networking capability for networking said computer servers, devices and platforms and networking capability for technologically pushing, pulling, forwarding, disseminating, sharing and/or streaming said relational information and data on health and health-care by and among said servers, devices and platforms in said networks and, coupled to said hardware and software, the innovative computer programs and software including stored procedures means for instructing, commanding and causing said processor units and memories to repetitively and continually transform random or chaotic events for encountering of, between and among said people seeking information and data on health, health-care, diseases, disorders and illness and related health and health-care services and managements of diseases, illnesses and disorders into ordered, guided and/or efficient encounters and efficient and optimal managements of said diseases, illnesses and disorders, and dispensations and disseminations of said information and data and services of, for, between and among people in diverse and different settings, circumstances and locations and for instantly and continually communicating, disseminating and/or technologically pushing, pulling, streaming and sharing said relational information and data on diagnoses, diseases and illnesses and managing and preventing said diseases, illnesses and disorders for, among and between people in said networks. Said commercial hardware and equipment and computer programs and software and technologies supporting the preferred embodiments of the present invention are briefly identified infra.

The present invention provides operating and functioning said computer servers possessing and operating memories, processors, at least a server operating system, a Windows Server, a SQL Server and computer scripting languages coupled to the innovative computer programs and software infra, a Visual Studio and .Net, Java Script, AJAX, HTML, XML, Flash and video, Web server, Microsoft IIS, Apache, Web browsers and said commercial computer programs and software and possessing and operating the present applicant's invented innovative computer programs and software for commanding and communicating for commanding and communicating with said SQL Server and said relational database and/or databases and coupling with said computer scripting languages and said innovative computer programs and software for creating and generating a plurality of individual interactive and adaptable related electronic templates, a plurality of interactive pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services in categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices, for creating, generating, expanding and improving SQL databases and tables comprising relational SQL keys related to said words and terms representing said in said SQL databases and tables in said SQL Server, for creating, compiling, pooling and relating relational information and data in said SQL databases and tables and relational SQL units, for repetitively scanning and checking for redundant duplicates or repeats, doubles in individual physicians' submissions related to individual diagnoses or individual syndromes or diagnoses in individual groups of diagnoses and related relational information and data in said SQL databases and tables, for removing said redundant duplicates or repeats, doubles from relational information and data from said SQL databases, tables and said relational SQL units and for not inserting said redundant duplicates or repeats, doubles into said relational information and data in said SQL databases and tables and relational SQL units, for creating, generating and maintaining said relational SQL units comprising relational SQL keys in said SQL databases and tables comprising plurality of said information and data tables, for creating, generating and maintaining individual unique relational SQL units comprising said relational SQL keys, for creating, generating and maintaining said unique relational SQL units comprising said relational SQL keys without redundant repeats and duplicates of SQL keys in said relational SQL units, for generating queries for said information on individual information on individual physicians' identities and practices and individual diagnoses and related treatments and differential diagnoses by people, for enabling said computer server or servers to process the relations of said words and terms and said relational SQL units and words and terms in said queries in said SQL Server and in said memories of said computer server or servers, for providing and instructing computer server or servers to execute algorithms for processing said relations of said words and terms and said relational SQL units and words and terms in said queries in said SQL Server and in said memories of said computer server or servers, for providing and instructing computer server or servers to sequentially scan and match said words and terms and said relational SQL units and words and terms in said queries, for providing and instructing computer server or servers to sequentially select said information on individual physicians' identities and practices and specialties individual diagnoses and related treatments and differential diagnoses on viewing screens and for providing and enabling said computer server or server to display said information on individual physicians' identities and practices and specialties individual diagnoses and related treatments and differential diagnoses on viewing screens.

The present invention provides said innovative computer programs and software invented by the present patent applicant which were filed with and are stored in the Library of Congress in Washington, D.C. The present invention uses also the commercially available computer software (plural), programs and computer languages such as, but not limited to, those made and sold by Adobe Systems, Inc. such as, but not limited to, Flash and Flash video and streaming technologies and Microsoft Corporation such as, but not limited to, Microsoft Windows Server operating system, Chrome operating system, Linux, SQL servers such as, but not limited to Microsoft SQL Server, MySQL and the like, Internet Explorer, various other Web browsers such as, but not limited to Firefox browser by Mozilla Foundation, Chrome Web browser, Safari, Opera and derivatives, Web server, Apache, Microsoft IIS, Visual Studio and .Net, Microsoft software including Notepad, Wordpad and .txt programs, dot Mobi and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XML, Ajax, .net, Wordpad, Notepad, .txt, Flash and video enabled programs and the like and related and their derivatives. Other computer programs and software also include application software (plural) also known as Applications or Apps for manipulating, texting, numbering, graphics, or any combinations of these elements for uses and applications with iPhone and iPad of Apple, Inc. and Google's Android software. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate.

It is to be understood that computer server, server, computer servers and/or servers of the present invention being used herein including in the claims also further embodied any and all computer servers, computers and mobile computers such as, but not limited to, and server blades and various hardware and equipment configurations, virtual servers such as those sold by VMware, HP and IBM, and their derivatives being used by many large American corporations can and will be used to implement the present invention for serving people using devices herein. Furthermore, it is to be understood that server, computer, servers and/or computers in the claims infra may also implied computer server, computer servers, virtual server and/or virtual servers and various hardware configurations for implementing the present invention.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention. Said programs and software and the derivatives and the like enabled individuals and individual groups of people to use and apply the present invention.

Further to supra, the present invention can incorporate, use and/or network with Skype—which was recently acquired by Microsoft Corp. in 2011 as Microsoft Skype Division and the like products and derivatives—to achieve the goals and objectives of the present invention.

However, the preferred embodiments of said pending patent applications supra and present invention and other pending applications of the present patent applicant motivated and caused the development and present implementation of clients-server system—all or almost all matters, events and communications of, by, among and between patients and physicians using said devices in USA and all over the world—are implemented and occurring in said network or networks of computer servers and virtual servers including push, pull, file sharing, streaming and disseminating technologies using commercially available program and software, such as, but not limited to, the Comet technology being sold by several companies such as, LightStreamer—http://www.lightstreamer.com—and the like and their derivatives and related for technologically push and pull for streaming and disseminating and propagating said outcomes including real-time information and data as described in the preferred embodiments of the present invention to said devices and platforms and other computer servers if linked to said networks. Said preferred embodiments also motivate and cause the sooner implementations of teleconferencing and video conferencing in and to occur in the system of network or networks of computer servers and devices so claimed in the claims of the present invention infra and said pending patent applications. Furthermore, said teleconferencing and videoconferencing also include, but not limited to, multipoint videoconferencing, instant messaging and mobile instant messaging.

Although the present invention is a vital component of the Cloud Healthcare Exchange created and formed by various pending patent applications of and the innovative computer programs and software invented, created, matured and applied by of the present patent applicant coupled to various commercially available computer hardware and equipment and various computer programs and software and technologies, one of the preferred embodiments of the present invention provides human civilization with the networks of patients and physicians and computer servers, teleconferencing platforms including video conferencing henceforth platforms and computers, laptops, hand-held and mobile communication devices and equipment—comprise keyboards and viewing screens including touch-enabled viewing screens or touch-screens and speech recognition technologies—enabled by Web browsers and said Web server in said network or networks for accessing and interacting with said servers and platforms henceforth devices being used by patients and physicians networked to said servers adaptable to technologically push, pull, forward, disseminate, share and/or stream relational information and data on health and health-care described herein. However, by default and the immensity of the present invention, clients to computer servers in said networks or cloud computing may depend on said push and pull as all events and matters and outcomes will occur and execute with said networks.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that said medical malpractices mean those actions and consequences caused by said physicians and/or patients in health-care and health-care services such as, but not limited to, failures, negligences, forgetfullness, lack of memories, disobediences, non-compliances said physicians and/or patients.

It is to be understood that the system and method taught by U.S. Pat. No. 6,132,218 entitled Images for communication of medical information in computer granted Oct. 17, 2000 to this present patent applicant will be incorporated into said preferred embodiments of the present invention to achieve the goals and objectives of the present invention.

It is to be understood that the present invention provides also voice-enabled means for interacting such as, but not limited to, speech recognition technology, Voice over Internet Protocol, IP telephony, Internet telephony, voice over broadband (VoBB), broadband telephony and broadband phone in said preferred embodiments.

Although the preferred embodiments of this invention have been described for humans and, in particular, malpractices of health-care providers including pharmacists and people who and entities prescribing and dispensing medications and drugs or foods and fluids, it will be appreciated by those skilled in the art that adaptations and variations of the present invention can be made to apply to other present and future conditions, matters, issues, events, interactions, encounters and circumstances affecting all species, animals, biological entities or structures, infectious particles or structures, and machines without departing from the spirit of the invention and the scope of the claims.

Although various preferred embodiments and representations of the present invention have been described, it will be appreciated by those skilled in the art that the real and practical implementations and their adaptations, variations and derivatives are and will be made and achieved without departing from the spirit and the scope of the claims of the present invention.

1. A system for reducing medical malpractices, delays, errors, inaccuracies, inefficiencies, mistakes, morbidity and mortality related to the health of and health-cares and health-care services provided to patients by physicians and health-care providers henceforth physicians for physicians and patients by a network or networks of computer servers, communication devices and platforms comprises:
functioning and operating said computer servers including virtual servers comprising a plurality of processors, memories, server operating systems, SQL Server, computer scripting languages, html, Java Script, Ajax coupled to innovative computer programs and software including stored procedures and various commercially available hardware including, but not limited to, routers, switches, modems and computer programs and software for technically pushing, pulling, file sharing and streaming and networking said servers and communication devices comprising computers, laptops, computer tablets, mobile and wireless communication devices possessing viewing screens including touch-enabled screens or touchscreens, keypads, Web browsers and speech recognition technologies and said platforms comprising teleconferencing platforms including video conferencing and said viewing screens and networking capability for technologically pushing, pulling, forwarding, disseminating, sharing and streaming said relational information and data to, between and among said servers, devices and platforms connected to the Internet;
said-processor-generated adaptable and expanding relations and compilations comprising individual diagnoses and/or syndromes, diagnoses and/or syndromes in individual groups of diagnoses and/or syndromes affecting organs, parts and anatomical sites of humans and related information and data in various headings encompassing related signs, symptoms, chief complaints and PQRST, differential diagnoses, reviews of systems, physical examinations, laboratories, imaging, body fluid tests and tissues examinations, organs and anatomical sites and parts of human, family histories, physiology, genetics, risks, risk factors, predispositions, sequelae, complications, immunizations, treatments, surgeries, procedures, medications, drugs and therapeutics and effects and side-effects on human organs and bodies of said medications, drugs and therapeutics and related prescriptions, uses, weanings, discontinuations and related sequelae, guidelines, protocols, referrals, recommendations and related individual patients, patients, patients' identities, individual physicians, physicians, physicians in individual groups of physicians, physicians' identities and physicians' specialties and/or practices henceforth people, people's identities and specialties and related relations of SQL keys in said SQL databases and tables;
said-processor-generated adaptable and expanding relations and compilations comprising individual interactive diagnoses and/or syndromes, diagnoses and/or syndromes in individual groups of diagnoses and/or syndromes and related interactive information and data in various headings in related interactive Web pages in said viewing screens;
said-processor-generated individual interactive diagnoses and/or syndromes and related differential diagnosis or diagnoses and related interactive information and data related to said headings and related to people, people's identities and specialties generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and said related interactive information and data in related interactive Web pages in said viewing screens;
said-processor-generated individual pooled consensuses, guidelines and protocols comprising individual interactive diagnoses and/or syndromes and related interactive information and data generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and related interactive information and data in related interactive Web pages in said viewing screens;
said-processor-generated extrapolations or predictions of individual diseases, illnesses and/or disorders and related individual interactive diagnoses and/or syndromes, diagnoses and/or syndromes in individual groups of diagnoses and/or syndromes and related interactive information and data in said headings from said adaptable and expanding relations and compilations in and among said SQL tables and databases related to said processor-generated individual diagnoses or syndromes and related information and data and related to said processor-generated individual pooled consensuses, guidelines and protocols related to individual diagnoses and/or syndromes and related information and data related to individual patients in associations with said processor-generated adaptable and expanding relations and compilations of individual interactive diagnoses and/or syndromes, diagnoses and/or syndromes in individual groups of diagnoses and/or syndromes and related interactive information and data in related interactive Web pages in said viewing screens;
said-processor-generated means for preventing or reducing said medical malpractices, delays, inefficiencies, mistakes, morbidity and mortality for physicians in associations as interactive means for preventing or reducing with said-processor-generated adaptable and expanding relations and compilations in said related interactive Web pages in said viewing screens;
said innovative computer programs and software for instructing and said processors and memories and said commercial computer programs and software for technologically and continually pushing, pulling, forwarding, disseminating, sharing and streaming said interactive means for preventing or reducing in associations with said processor-generated adaptable and expanding relations and compilations in interactive related Web pages in said viewing screens of said computer servers, devices and platforms in said network or networks;
said-processor-generated means for coordinating said health-cares and health-care services between and among patients and physicians in associations as interactive means for coordinating with said-processor-generated adaptable and expanding relations and compilations in said related interactive Web pages in said viewing screens;
said innovative computer programs and software, processors and memories and computer programs and software, processors and memories for preventing or reducing said medical malpractices, delays, delays, inefficiencies, mistakes, morbidity and mortality for said people in said network or networks; and
said innovative computer programs and software, processors and memories and said commercial computer programs and software for generating said adaptable and expanding relations and compilations, means for preventing or reducing means for and means for coordinating in said network or networks.

2. The system according to claim 1 wherein said said-processor-generated means for preventing or reducing said medical malpractices, delays, inefficiencies, mistakes, morbidity and mortality for physicians in associations as interactive means for preventing or reducing with said-processor-generated adaptable and expanding relations and compilations in said related interactive Web pages in said viewing screens comprises:
i. said-processor-generated individual interactive diagnoses and/or syndromes and related differential diagnosis or diagnoses and related interactive information and data related to said headings and related to people, people's identities and specialties generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and said related interactive information and data related to people, people's identities and specialties in related interactive Web pages in said viewing screens;
ii. processor-generated extrapolations or predictions of individual diseases, illnesses and/or disorders and related diagnoses and/or syndromes, diagnoses and/or syndromes in individual groups of diagnoses and/or syndromes and related information and data including risks, risk factors, predispositions, sequelae and complications in said headings from said adaptable and expanding relations and compilations in and among said SQL tables and databases related to said processor-selected individual diagnoses and/or syndromes and related information and data related to said headings and related to people, people's identities and specialties in said viewing screens being used by, between and among said people;
said-commercial-computer-programs-and-software-pushed, pulled, streamed and shared said-processor-extrapolated or predicted individual diseases, illnesses and/or disorders and related diagnoses and/or syndromes, diagnoses and/or syndromes in individual groups of diagnoses and/or syndromes and related information and data including risks, risk factors, predispositions, sequelae and complications in said headings from said adaptable and expanding relations and compilations in and among said SQL tables and databases related to said processor-selected individual diagnoses and/or syndromes and related information and data related to said headings and related to people, people's identities and specialties in associations with said interactive compositions in said viewing screens;
iii. said-processor-generated individual pooled consensuses, guidelines and protocols comprising individual interactive diagnoses and/or syndromes and related interactive information and data generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and related interactive information and data related to people, people's identities and specialties in related interactive Web pages in said viewing screens;
said-commercial-computer-programs-and-software-pushed, pulled, streamed and shared said-processor-generated individual pooled consensuses, guidelines and protocols related to people, people's identities and specialties in associations with said interactive compositions in said viewing screens;
said-processor-generated extrapolations or predictions of individual diseases, illnesses and/or disorders and related individual interactive diagnoses and/or syndromes, diagnoses and/or syndromes in individual groups of diagnoses and/or syndromes and related interactive information and data in said headings from said adaptable and expanding relations and compilations in and among said SQL tables and databases related to said processor-generated individual diagnoses or syndromes and related information and data and related to said processor-generated individual pooled consensuses, guidelines and protocols related to individual diagnoses and/or syndromes and related information and data related to individual patients in associations with said processor-generated adaptable and expanding relations and compilations of individual interactive diagnoses and/or syndromes, diagnoses and/or syndromes in individual groups of diagnoses and/or syndromes and related interactive information and data related to people, people's identities and specialties in related interactive Web pages in said viewing screens; and
said-commercial-computer-programs-and-software-pushed, pulled, streamed and shared said-processor-extrapolated or predicted individual diseases, illnesses and/or disorders and related diagnoses and/or syndromes, diagnoses and/or syndromes in individual groups of diagnoses and/or syndromes and related information and data related to said processor-generated individual pooled consensuses, guidelines and protocols and related information and data related to said headings and related to people, people's identities and specialties in associations with said interactive compositions in said viewing screens;
said-processor-generated extrapolations or predictions of individual diseases, illnesses and/or disorders and related individual interactive diagnoses and/or syndromes, diagnoses and/or syndromes in individual groups of diagnoses and/or syndromes and related interactive information and data generated by said processors and memories from said adaptable and expanding relations and compilations related to said-processor-generated individual diagnoses or syndromes and related information and data and related to said-processor-generated individual pooled consensuses, guidelines and protocols related to individual diagnoses and/or syndromes and related information and data related to individual patients and physicians in associations with said-processor-generated adaptable and expanding relations and compilations of interactive individual diagnoses and/or syndromes, diagnoses and/or syndromes in individual groups of diagnoses and/or syndromes and related interactive information and data related to people, people's identities and specialties in related interactive Web pages in said viewing screens.

3. The system according to claim 1 wherein said-processor-generated means for preventing or reducing said medical malpractices, delays, inefficiencies, mistakes, morbidity and mortality for physicians in associations as interactive means for preventing or reducing with said-processor-generated adaptable and expanding relations and compilations in said related interactive Web pages in said viewing screens further comprises said-processor-generated visually contrast, distinguished and/or highlighted individual diagnoses, syndromes, diagnoses and/or syndromes and related information and data in said various headings, differential diagnoses and related information and data in said various headings and people, people's identities and specialties in and among technologically pushed, pulled, forwarded, streamed and disseminated said individual interactive pooled consensuses, guidelines, protocols, diagnoses, syndromes and related information and data and related people, people's identities and specialties and extrapolations or forecasts in said related interactive electronic Web pages.

4. The system according to claim 1 wherein said innovative computer programs and software, processors and memories and said commercial computer programs and software for coordinating said health-cares and health-care services between and among patients and physicians by said computer servers, devices and platforms in said network or networks comprises:
i. said-processor-generated individual interactive diagnoses and/or syndromes and related differential diagnosis or diagnoses and related interactive information and data related to said headings and related to people, people's identities and specialties generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and said related interactive information and data related to people, people's identities and specialties in related interactive Web pages in said viewing screens;
ii. processor-generated extrapolations or predictions of individual diseases, illnesses and/or disorders and related diagnoses and/or syndromes, diagnoses and/or syndromes in individual groups of diagnoses and/or syndromes and related information and data including risks, risk factors, predispositions, sequelae and complications in said headings from said adaptable and expanding relations and compilations in and among said SQL tables and databases related to said processor-selected individual diagnoses and/or syndromes and related information and data related to said headings and related to people, people's identities and specialties in said viewing screens being used by, between and among said people;
said-commercial-computer-programs-and-software-pushed, pulled, streamed and shared said-processor-extrapolated or predicted individual diseases, illnesses and/or disorders and related diagnoses and/or syndromes, diagnoses and/or syndromes in individual groups of diagnoses and/or syndromes and related information and data including risks, risk factors, predispositions, sequelae and complications in said headings from said adaptable and expanding relations and compilations in and among said SQL tables and databases related to said processor-selected individual diagnoses and/or syndromes and related information and data related to said headings and related to people, people's identities and specialties in associations with said interactive compositions in said viewing screens;
iii. said-processor-generated individual pooled consensuses, guidelines and protocols comprising individual interactive diagnoses and/or syndromes and related interactive information and data generated by said processors and memories from said adaptable and expanding relations and compilations in associations with said processor-generated adaptable and expanding relations and compilations of individual interactive diagnoses and/or syndromes, diagnoses and/or syndromes in individual groups of diagnoses and/or syndromes and related interactive information and data related to people, people's identities and specialties in related interactive Web pages in said viewing screens;
said-commercial-computer-programs-and-software-pushed, pulled, streamed and shared said-processor-generated individual pooled consensuses, guidelines and protocols related to people, people's identities and specialties in associations with said interactive compositions in said viewing screens;
said-processor-generated extrapolations or predictions of individual diseases, illnesses and/or disorders and related individual interactive diagnoses and/or syndromes, diagnoses and/or syndromes in individual groups of diagnoses and/or syndromes and related interactive information and data in said headings from said adaptable and expanding relations and compilations in and among said SQL tables and databases related to said processor-generated individual diagnoses or syndromes and related information and data and related to said processor-generated individual pooled consensuses, guidelines and protocols related to individual diagnoses and/or syndromes and related information and data related to individual patients in associations with said processor-generated adaptable and expanding relations and compilations of individual interactive diagnoses and/or syndromes, diagnoses and/or syndromes in individual groups of diagnoses and/or syndromes and related interactive information and data related to people, people's identities and specialties in related interactive Web pages in said viewing screens;
said-commercial-computer-programs-and-software-pushed, pulled, streamed and shared said-processor-extrapolated or predicted individual diseases, illnesses and/or disorders and related diagnoses and/or syndromes, diagnoses and/or syndromes in individual groups of diagnoses and/or syndromes and related information and data related to said processor-generated individual pooled consensuses, guidelines and protocols and related information and data related to said headings and related to people, people's identities and specialties in associations with said interactive compositions in said viewing screens; and
said-processor-generated extrapolations or predictions of individual diseases, illnesses and/or disorders and related individual interactive diagnoses and/or syndromes, diagnoses and/or syndromes in individual groups of diagnoses and/or syndromes and related interactive information and data generated by said processors and memories from said adaptable and expanding relations and compilations related to said-processor-generated individual diagnoses or syndromes and related information and data and related to said-processor-generated individual pooled consensuses, guidelines and protocols related to individual diagnoses and/or syndromes and related information and data related to individual patients and physicians in associations with said-processor-generated adaptable and expanding relations and compilations of interactive individual diagnoses and/or syndromes, diagnoses and/or syndromes in individual groups of diagnoses and/or syndromes and related interactive information and data related to people, people's identities and specialties in related interactive Web pages in said viewing screens.

5. The system according to claim 1 wherein said said-processor-generated means for for coordinating said health-cares and health-care services between and among patients and physicians in associations as interactive means for coordinating with said-processor-generated adaptable and expanding relations and compilations in said related interactive Web pages in said viewing screens comprises said-processor-generated visually contrast, distinguished and/or highlighted individual diagnoses, syndromes, diagnoses and/or syndromes and related information and data in said various headings, differential diagnoses and related information and data in said various headings and people, people's identities and specialties in and among technologically pushed, pulled, forwarded, streamed and disseminated said individual interactive pooled consensuses, guidelines, protocols, diagnoses, syndromes and related information and data and related people, people's identities and specialties and extrapolations or forecasts in said related interactive electronic Web pages.

6. The system according to claim 1 wherein said innovative computer programs and software, processors and memories and computer programs and software, processors and memories for preventing or reducing said medical malpractices, delays, delays, inefficiencies, mistakes, morbidity and mortality for said people in said network or networks comprises:
said computer servers comprising said processors and memories coupled to said innovative computer programs and software and commercial computer programs and software in a network or networks of said servers, devices, platforms and the Internet;
said-processor-generated means for preventing or reducing said medical malpractices, delays, inefficiencies, mistakes, morbidity and mortality for physicians in associations as interactive means for preventing or reducing with said-processor-generated adaptable and expanding relations and compilations in said related interactive Web pages in said viewing screens;
said-processor-generated means for coordinating said health-cares and health-care services between and among patients and physicians in associations as interactive means for preventing or reducing with said-processor-generated adaptable and expanding relations and compilations in said related interactive Web pages in said viewing screens;
said innovative computer programs and software for instructing and said processors and memories and said commercial computer programs and software for technologically and continually pushing, pulling, forwarding, disseminating, sharing and streaming said interactive means for preventing or reducing and said interactive means for coordinating in associations with said processor-generated adaptable and expanding relations and compilations in interactive related Web pages in said viewing screens of said computer servers, devices and platforms in said network or networks; and
said innovative computer programs and software, processors and memories and commercial computer programs and software for technologically and continually pushing, pulling, forwarding, disseminating, sharing and streaming said interactive means for preventing or reducing and interactive means for coordinating in associations with said-processor-generated adaptable and expanding relations and compilations in said interactive related Web pages in said viewing screens of said computer servers, devices and platforms in said network or networks.

7. In a system for reducing medical malpractices, delays, errors, inaccuracies, inefficiencies, mistakes, morbidity and mortality related to the health of and health-cares and health-care services provided to patients by physicians and health-care providers henceforth physicians for physicians and patients by a network or networks of computer servers, communication devices and platforms, a method for preventing or reducing said medical malpractices, delays, delays, inefficiencies, mistakes, morbidity and mortality for said people by said servers, devices and platforms in said network or networks comprises:
a process for operating said functioning and operating functioning said computer servers including virtual servers comprising a plurality of processors, memories, server operating systems, SQL Server, computer scripting languages, html, Java Script, Ajax coupled to innovative computer programs and software including stored procedures and various commercially available hardware including, but not limited to, routers, switches, modems and computer programs and software for technically pushing, pulling, file sharing and streaming and networking said servers and communication devices comprising computers, laptops, computer tablets, mobile and wireless communication devices possessing viewing screens including touch-enabled screens or touchscreens, keypads, Web browsers and speech recognition technologies and said platforms comprising teleconferencing platforms including video conferencing and said viewing screens and networking capability for technologically pushing, pulling, forwarding, disseminating, sharing and streaming said relational information and data to, between and among said servers, devices and platforms connected to the Internet;
said innovative computer programs and software including stored procedures instruct and cause said processors and memories to generate adaptable and expanding relations and compilations comprising individual diagnoses and/or syndromes, diagnoses and/or syndromes in individual groups of diagnoses and/or syndromes affecting organs, parts and anatomical sites of humans and related information and data in various headings encompassing related signs, symptoms, chief complaints and PQRST, differential diagnoses, reviews of systems, physical examinations, laboratories, imaging, body fluid tests and tissues examinations, organs and anatomical sites and parts of human, family histories, physiology, genetics, risks, risk factors, predispositions, sequelae, complications, immunizations, treatments, surgeries, procedures, medications, drugs and therapeutics and effects and side-effects on human organs and bodies of said medications, drugs and therapeutics and related prescriptions, uses, weanings, discontinuations and related sequelae, guidelines, protocols, referrals, recommendations and related individual patients, patients, patients' identities, individual physicians, physicians, physicians in individual groups of physicians, physicians' identities and physicians' specialties and/or practices henceforth people, people's identities and specialties and related relations of SQL keys in said SQL databases and tables;
said innovative computer programs and software instruct and cause said processors and memories and said commercial computer programs and software to generate individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;
said innovative computer programs and software, processors and memories and said commercial computer programs and software for generating said adaptable and expanding relations and compilations, means for preventing or reducing means for and means for coordinating and associating said means with said individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;
said innovative computer programs and software instruct and cause said processors and memories and commercial computer programs and software to generate said means for preventing or reducing said medical malpractices, delays, delays, inefficiencies, mistakes, morbidity and mortality for physicians and to associate said means as interactive means with said individual adaptable, expanding and interactive relations and compilations in said in individual related interactive electronic Web pages interactive with said individual patients and related physicians in said viewing screens in said network or networks;
said innovative computer programs and software instruct and cause said processors and memories and commercial computer programs and software to generate said means for coordinating said health-cares and health-care services between and among patients and physicians and to associate as interactive means with said-processor-generated adaptable and expanding relations and compilations in said related interactive Web pages in said viewing screens to reduce or prevent said malpractices, delays, errors, inaccuracies, inefficiencies, mistakes, morbidity and mortality for physicians and patients by said servers, devices and platforms in said network or networks;
said innovative computer programs and software instruct and cause said processors and memories and commercial computer programs and software to technologically push, pull, forward, stream and disseminate said processor-generated means and to associate said means for preventing or reducing and said means for coordinating and to associate with said individual adaptable, expanding and interactive relations and compilations in individual related interactive electronic Web pages interactive with said individual patients and related physicians in said viewing screens in said network or networks;
said innovative computer programs and software including stored procedures and said computer programs and software, processors and memories to visually contrast, distinguish and highlight individual interactive diagnoses, syndromes, diagnoses and/or syndromes and related interactive differential diagnoses and related interactive information and data in said various headings and people, people's identities and specialties in and among said pushed, pulled, forwarded, streamed and disseminated individual interactive pooled consensuses, guidelines, protocols, diagnoses, syndromes and extrapolations or forecasts and related information and data and related people, people's identities and specialties in said related interactive electronic Web pages;
said innovative computer programs and software, computer programs and software, processors and memories to prevent or reduce said medical malpractices, delays, delays, inefficiencies, mistakes, morbidity and mortality for said people in said network or networks; and
said innovative computer programs and software, computer programs and software, processors and memories to coordinate health-cares and health-care services between and among patients and physicians in said network or networks.

8. The method according to claim 7 wherein said innovative computer programs and software, computer programs and software, processors and memories to prevent or reduce said medical malpractices, delays, delays, inefficiencies, mistakes, morbidity and mortality for said people in said network or networks comprises:
said innovative computer programs and software instruct and cause said processors and memories and said computer programs and software to associate or relate said means for preventing or reducing as interactive means to said individual adaptable, expanding and interactive relations and compilations in said interactive relate Web pages in said viewing screens of said servers, devices and platforms being used by said people;
i. said innovative computer programs and software instruct and cause said processors and memories to select individual diagnoses and/or syndromes and related differential diagnosis or diagnoses in said adaptable and expanding relations and compilations in individual responses to any components in said headings inputted into said processors and memories by said people using information and data in said headings in said viewing screens and said computer programs and software to display said processor-selected individual diagnoses and/or syndromes and related information and data related to said headings and related to people, people's identities and specialties and related differential diagnosis or diagnoses in said interactive compositions and interactive with said people in said viewing screens;
if said processor-generated individual diagnoses or syndromes and related information and data were selected by individual physicians or between or among physicians in a group physicians using clicks, keyboards, touches, speech recognition or any combination thereof, first, said innovative computer programs and software instruct and cause said processors and memories to process said selected individual diagnoses or syndromes and related information and data and related differential diagnosis or diagnoses and to compile and relate in said adaptable and expanding relations and compilations in and among said SQL tables and databases, and, consequently, said commercial computer programs and software to technogically push, pull, forward and stream said diagnoses and related information and data and related differential diagnosis or diagnoses in said interactive compositions in said viewing screens;
second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related said information and in said headings related to individual patients and related physicians related to said processor-generated individual diagnoses or syndromes and related information and data from said adaptable and expanding relations and compilations and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties to associate with said interactive compositions in said viewing screens being used by said people;
ii. said innovative computer programs and software instruct and cause said processors and memories to compose individual pooled consensuses, guidelines and protocols related to individual diagnoses and/or syndromes and related information and data in said headings from said adaptable and expanding relations and compile and associate said individual pooled consensuses, guidelines and protocols with said individual diagnoses and/or syndromes, diagnoses and/or syndromes in individual groups of diagnoses and/or syndromes in said interactive compositions in said viewing screens, after said processors and memories received any components of said headings inputted into said processors and memories by individual patients and/or physicians;
if said processor-generated individual pooled consensuses, guidelines and/or protocols and related information and data in said headings were selected and submitted to said processors and memories by individual physicians or between or among physicians in a group physicians, first, said innovative computer programs and software instruct and cause said processors and memories to process said inputs and to compile and relate in said adaptable and expanding relations and compilations in and among said SQL tables and databases, and, consequently, said commercial computer programs and software to technologically push, pull, forward and stream said diagnoses and related information and data in said interactive compositions in said viewing screens being used by said people;
said innovative computer programs and software instruct and cause said processors and memories to identify and select said individual diagnoses and related treatments and managements of diseases, illnesses and disorders and related prescriptions, uses, discontinuations and weanings of related medications and/or treatments in said adaptable and expanding relations and compilations according to said consensuses, guidelines and protocols;
second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related information and data related to individual patients and physicians related to said selected and submitted information and data submitted to said processors and memories comprising and related information and data from said adaptable and expanding relations and compilations in and among said SQL tables and databases and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties in said viewing screens being used by said people; and
said innovative computer programs and software including stored procedures instruct and cause said processors and memories extrapolate or predict individual diseases, illnesses and/or disorders and related individual interactive diagnoses and/or syndromes, diagnoses and/or syndromes in individual groups of diagnoses and/or syndromes and related interactive information and data generated from said adaptable and expanding relations and compilations related to said-processor-generated individual diagnoses or syndromes and related information and data and related to said-processor-generated individual pooled consensuses, guidelines and protocols related to individual diagnoses and/or syndromes and related information and data related to individual patients and physicians in associations with said-processor-generated adaptable and expanding relations and compilations of interactive individual diagnoses and/or syndromes, diagnoses and/or syndromes in individual groups of diagnoses and/or syndromes and related interactive information and data related to people, people's identities and specialties and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said identities and specialties in said viewing screens being used by said people.

9. The method according to claim 7 wherein said innovative computer programs and software instruct and cause said processors and memories and commercial computer programs and software to generate said means for coordinating said health-cares and health-care services between and among patients and physicians and to associate as interactive means with said-processor-generated adaptable and expanding relations and compilations in said related interactive Web pages in said viewing screens to reduce or prevent said malpractices, delays, errors, inaccuracies, inefficiencies, mistakes, morbidity and mortality for physicians and patients by said servers, devices and platforms in said network or networks comprises:
said innovative computer programs and software instruct and cause said processors and memories and said computer programs and software to associate or relate said means for preventing or reducing as interactive means to said individual adaptable, expanding and interactive relations and compilations in said interactive relate Web pages in said viewing screens of said servers, devices and platforms being used by said people;
i. said innovative computer programs and software instruct and cause said processors and memories to select individual diagnoses and/or syndromes and related differential diagnosis or diagnoses in said adaptable and expanding relations and compilations in individual responses to any components in said headings inputted into said processors and memories by said people using information and data in said headings in said viewing screens and said computer programs and software to display said processor-selected individual diagnoses and/or syndromes and related information and data related to said headings and related to people, people's identities and specialties and related differential diagnosis or diagnoses in said interactive compositions and interactive with said people in said viewing screens;
if said processor-generated individual diagnoses or syndromes and related information and data were selected by individual physicians or between or among physicians in a group physicians using clicks, keyboards, touches, speech recognition or any combination thereof, first, said innovative computer programs and software instruct and cause said processors and memories to process said selected individual diagnoses or syndromes and related information and data and related differential diagnosis or diagnoses and to compile and relate in said adaptable and expanding relations and compilations in and among said SQL tables and databases, and, consequently, said commercial computer programs and software to technogically push, pull, forward and stream said diagnoses and related information and data and related differential diagnosis or diagnoses in said interactive compositions in said viewing screens;
second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related said information and in said headings related to individual patients and related physicians related to said processor-generated individual diagnoses or syndromes and related information and data from said adaptable and expanding relations and compilations and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties to associate with said interactive compositions in said viewing screens being used by said people;
ii. said innovative computer programs and software instruct and cause said processors and memories to compose individual pooled consensuses, guidelines and protocols related to individual diagnoses and/or syndromes and related information and data in said headings from said adaptable and expanding relations and compile and associate said individual pooled consensuses, guidelines and protocols with said individual diagnoses and/or syndromes, diagnoses and/or syndromes in individual groups of diagnoses and/or syndromes in said interactive compositions in said viewing screens, after said processors and memories received any components of said headings inputted into said processors and memories by individual patients and/or physicians;
if said processor-generated individual pooled consensuses, guidelines and/or protocols and related information and data in said headings were selected and submitted to said processors and memories by individual physicians or between or among physicians in a group physicians, first, said innovative computer programs and software instruct and cause said processors and memories to process said inputs and to compile and relate in said adaptable and expanding relations and compilations in and among said SQL tables and databases, and, consequently, said commercial computer programs and software to technologically push, pull, forward and stream said diagnoses and related information and data in said interactive compositions in said viewing screens being used by said people;
said innovative computer programs and software instruct and cause said processors and memories to identify and select said individual diagnoses and related treatments and managements of diseases, illnesses and disorders and related prescriptions, uses, discontinuations and weanings of related medications and/or treatments in said adaptable and expanding relations and compilations according to said consensuses, guidelines and protocols;
second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related information and data related to individual patients and physicians related to said selected and submitted information and data submitted to said processors and memories comprising and related information and data from said adaptable and expanding relations and compilations in and among said SQL tables and databases and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties in said viewing screens being used by said people; and
said innovative computer programs and software including stored procedures instruct and cause said processors and memories extrapolate or predict individual diseases, illnesses and/or disorders and related individual interactive diagnoses and/or syndromes, diagnoses and/or syndromes in individual groups of diagnoses and/or syndromes and related interactive information and data generated from said adaptable and expanding relations and compilations related to said-processor-generated individual diagnoses or syndromes and related information and data and related to said-processor-generated individual pooled consensuses, guidelines and protocols related to individual diagnoses and/or syndromes and related information and data related to individual patients and physicians in associations with said-processor-generated adaptable and expanding relations and compilations of interactive individual diagnoses and/or syndromes, diagnoses and/or syndromes in individual groups of diagnoses and/or syndromes and related interactive information and data related to people, people's identities and specialties and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said identities and specialties in said viewing screens being used by said people.

10. In a system for reducing medical malpractices, delays, errors, inaccuracies, inefficiencies, mistakes, morbidity and mortality related to the health of and health-cares and health-care services provided to patients by physicians and health-care providers henceforth physicians for physicians and patients by a network or networks of computer servers, communication devices and platforms, a method for coordinating said health, health-cares and services between and among patients and physicians by said computer servers, communication devices and platforms in said network or networks to reduce or prevent said malpractices, delays, errors, inaccuracies, inefficiencies, mistakes, morbidity and mortality comprises:
a process for operating said functioning and operating said computer servers comprising said processors and memories coupled to said innovative computer programs and software including stored procedures and commercial computer programs and software in said network or networks of said servers, devices, platforms and Internet;
said innovative computer programs and software instruct and cause said processors and memories and said commercial computer programs and software to generate individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;
said innovative computer programs and software instruct and cause said processors and memories and commercial computer programs and software to generate said means for preventing or reducing said medical malpractices, delays, delays, inefficiencies, mistakes, morbidity and mortality for physicians and to associate said means as interactive means with said individual adaptable, expanding and interactive relations and compilations in said in individual related interactive electronic Web pages interactive with said individual patients and related physicians in said viewing screens in said network or networks;
said innovative computer programs and software instruct and cause said processors and memories and commercial computer programs and software to coordinate said health-cares and health-care services between and among patients and physicians by said network or networks;
said innovative computer programs and software instruct and cause said processors and memories and commercial computer programs and software to generate said means for coordinating said health-cares and health-care services between and among patients and physicians and to associate as interactive means with said-processor-generated adaptable and expanding relations and compilations in said related interactive Web pages in said viewing screens to reduce or prevent said malpractices, delays, errors, inaccuracies, inefficiencies, mistakes, morbidity and mortality for physicians and patients by said servers, devices and platforms in said network or networks.
said innovative computer programs and software, processors and memories and said commercial computer programs and software for generating said adaptable and expanding relations and compilations, means for preventing or reducing means for and means for coordinating and associating said means with said individual adaptable and expanding relations and compilations of interactive individual diagnoses and/or syndromes, diagnoses and/or syndromes in individual groups of diagnoses and/or syndromes and related interactive information and data in various headings in related interactive Web pages in said viewing screens;
said innovative computer programs and software instruct and cause said processors and memories and said commercial computer programs and software to technologically and continually push, pull, forward, stream and disseminate said individual interactive pooled consensuses, guidelines and protocols related to individual diagnoses and/or syndromes, diagnoses and/or syndromes in individual groups of diagnoses and/or syndromes and related information and data in said various headings and related differential diagnoses and related and extrapolations or forecasts and related people, people's identities and specialties and to associate as interactive means for preventing or reducing and means for coordinating with said individual adaptable, expanding and interactive relations and compilations in individual related interactive electronic Web pages interactive with said individual patients and related physicians in said viewing screens in said network or networks; and
said innovative computer programs and software instruct and cause said processors and memories and said computer programs and software to visually contrasting, distinguishing and highlighting individual diagnoses, syndromes, diagnoses and syndromes, differential diagnoses and related information and data in said various headings and people, people's identities and specialties in and among said pushed, pulled, forwarded, streamed and disseminated said individual interactive pooled consensuses, guidelines, protocols, diagnoses, syndromes, differential diagnoses and extrapolations or forecasts and related people, people's identities and specialties and related interactive information and data in said related interactive electronic Web pages to be interactive in said viewing screen with said people using said devices and platforms; and
said innovative computer programs and software, computer programs and software, processors and memories to prevent or reduce said medical malpractices, delays, delays, inefficiencies, mistakes, morbidity and mortality for said people in said network or networks; and
said innovative computer programs and software, computer programs and software, processors and memories to coordinate health-cares and health-care services between and among patients and physicians in said network or networks.

11. The method according to claim 10 wherein said innovative computer programs and software instruct and cause said processors and memories and commercial computer programs and software to coordinate said health-cares and health-care services between and among patients and physicians by said network or networks to reduce or prevent said malpractices, delays, errors, inaccuracies, inefficiencies, mistakes, morbidity and mortality for said physicians and patients comprises:
said innovative computer programs and software instruct and cause said processors and memories and said commercial computer programs and software to generate individual adaptable and expanding relations and compilations of interactive individual diagnoses and/or syndromes, diagnoses and/or syndromes in individual groups of diagnoses and/or syndromes and related interactive information and data in various headings and related people, people's identities and specialties in related interactive Web pages in said viewing screens; and
said innovative computer programs and software instruct and cause said processors and memories and commercial computer programs and software to generate said means for coordinating said health-cares and health-care services between and among patients and physicians and to associate as interactive means with said-processor-generated adaptable and expanding relations and compilations in said related interactive Web pages in said viewing screens to reduce or prevent said malpractices, delays, errors, inaccuracies, inefficiencies, mistakes, morbidity and mortality for physicians and patients by said servers, devices and platforms in said network or networks.

12. The method according to claim 10 wherein said innovative computer programs and software instruct and cause said processors and memories and commercial computer programs and software to generate said means for coordinating said health-cares and health-care services between and among patients and physicians and to associate as interactive means with said-processor-generated adaptable and expanding relations and compilations in said related interactive Web pages in said viewing screens to reduce or prevent said malpractices, delays, errors, inaccuracies, inefficiencies, mistakes, morbidity and mortality for physicians and patients by said servers, devices and platforms in said network or networks comprises:
i. said innovative computer programs and software instruct and cause said processors and memories to select individual diagnoses and/or syndromes and related differential diagnosis or diagnoses in said adaptable and expanding relations and compilations in individual responses to any components in said headings inputted into said processors and memories by said people using information and data in said headings in said viewing screens and said computer programs and software to display said processor-selected individual diagnoses and/or syndromes and related information and data related to said headings and related to people, people's identities and specialties and related differential diagnosis or diagnoses in said interactive compositions and interactive with said people in said viewing screens;
if said processor-generated individual diagnoses or syndromes and related information and data were selected by individual physicians or between or among physicians in a group physicians using clicks, keyboards, touches, speech recognition or any combination thereof, first, said innovative computer programs and software instruct and cause said processors and memories to process said selected individual diagnoses or syndromes and related information and data and related differential diagnosis or diagnoses and to compile and relate in said adaptable and expanding relations and compilations in and among said SQL tables and databases, and, consequently, said commercial computer programs and software to technogically push, pull, forward and stream said diagnoses and related information and data and related differential diagnosis or diagnoses in said interactive compositions in said viewing screens;
second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related said information and in said headings related to individual patients and related physicians related to said processor-generated individual diagnoses or syndromes and related information and data from said adaptable and expanding relations and compilations and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties to associate with said interactive compositions in said viewing screens being used by said people;
ii. said innovative computer programs and software instruct and cause said processors and memories to compose individual pooled consensuses, guidelines and protocols related to individual diagnoses and/or syndromes and related information and data in said headings from said adaptable and expanding relations and compile and associate said individual pooled consensuses, guidelines and protocols with said individual diagnoses and/or syndromes, diagnoses and/or syndromes in individual groups of diagnoses and/or syndromes in said interactive compositions in said viewing screens, after said processors and memories received any components of said headings inputted into said processors and memories by individual patients and/or physicians;
if said processor-generated individual pooled consensuses, guidelines and/or protocols and related information and data in said headings were selected and submitted to said processors and memories by individual physicians or between or among physicians in a group physicians, first, said innovative computer programs and software instruct and cause said processors and memories to process said inputs and to compile and relate in said adaptable and expanding relations and compilations in and among said SQL tables and databases, and, consequently, said commercial computer programs and software to technologically push, pull, forward and stream said diagnoses and related information and data in said interactive compositions in said viewing screens being used by said people;
said innovative computer programs and software instruct and cause said processors and memories to identify and select said individual diagnoses and related treatments and managements of diseases, illnesses and disorders and related prescriptions, uses, discontinuations and weanings of related medications and/or treatments in said adaptable and expanding relations and compilations according to said consensuses, guidelines and protocols;
second, said innovative computer programs and software instruct and cause said processors and memories to extrapolate or forecast individual diseases, illnesses and/or disorders and related diagnoses and/or syndromes, diagnoses and/or syndromes in individual groups of diagnoses and/or syndromes and related information and data related to individual patients and physicians related to said selected and submitted information and data submitted to said processors and memories comprising and related information and data from said adaptable and expanding relations and compilations in and among said SQL tables and databases and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said people, people's identities and specialties in said viewing screens being used by said people; and
said innovative computer programs and software including stored procedures instruct and cause said processors and memories extrapolate or predict individual diseases, illnesses and/or disorders and related individual interactive diagnoses and/or syndromes, diagnoses and/or syndromes in individual groups of diagnoses and/or syndromes and related interactive information and data generated from said adaptable and expanding relations and compilations related to said-processor-generated individual diagnoses or syndromes and related information and data and related to said-processor-generated individual pooled consensuses, guidelines and protocols related to individual diagnoses and/or syndromes and related information and data related to individual patients and physicians in associations with said-processor-generated adaptable and expanding relations and compilations of interactive individual diagnoses and/or syndromes, diagnoses and/or syndromes in individual groups of diagnoses and/or syndromes and related interactive information and data related to people, people's identities and specialties and to instruct and cause said commercial computer programs and software to technogically push, pull, forward and stream said processor-selected individual diseases, illnesses and/or disorders and related diagnoses and/or syndromes, diagnoses and/or syndromes in individual groups of diagnoses and/or syndromes and related information and data and related said identities and specialties in said viewing screens being used by said people.
